(19) United States
(12) Patent Application Publication
(10) Pub. No.: US 2006/0168413 A1
(43) Pub. Date: Jul. 27, 2006

(54) Method for regulating access to data in at least one data storage device in a system consisting of several individual systems

(76) Inventor: Thomas Schoebel-Theuer, Stuttgart (DE)

Correspondence Address: FLYNN THIEL BOUTELL & TANIS, P.C., 2026 RAMBLING ROAD, KALAMAZOO, MI, 49008-1631, US

(21) Appl. No.: 10/529,435

(22) PCT Filed: Sep. 29, 2003
(86) PCT No.: PCT/EP03/10794

§ 371 Date: Mar. 25, 2005

(30) Foreign Application Priority Data
Sep. 30, 2002 (DE) 10246369.7
Sep. 30, 2002 (DE) 10246367.0

(51) Int. Cl. G06F 12/14

(52) U.S. Cl. 711/163

(57) ABSTRACT

The invention proposes methods and apparatuses for regulating access to data in at least one data storage device in a system comprising a plurality of individual systems (10-12), in which the individual systems (10-12) reserve themselves free data areas or address areas in the data storage device and the reserved areas are then blocked for access by other individual systems (10-12), with areas (20, 23) which are speculatively extended in comparison with the directly required areas (18, 21) being reserved. This makes it possible to achieve reduced data traffic and shorter latencies.

The invention relates to a method for regulating access to data in at least one data storage device in a system comprising a plurality of individual systems, where the access operations may overlap and intersect one another in terms of timing and data area. Particularly in the case of data access in distributed systems, the access time or latency and the maximum data rate, which limits the throughput, present a large problem. This problem appears in the shape of the “memory gap” in stand-alone systems, too, and has been known for a long time as the “bottleneck problem”.

To solve this bottleneck problem, two tried-and-tested, fundamental strategies are known: attempts at the solution involve either hardware upgrades or to reduce the strain required to achieve an object. While continual progress has been made in the past, and will probably continue to be made, both in terms of the latencies and in terms of the throughput in the hardware of conventional peripheral devices, such progress is possible only in the throughput, but not in the latency, of systems which are distributed over a large area, since the communication is limited by the speed of light. This means that unnecessary data traffic and unnecessary waiting for the execution of operations needs to be avoided much more urgently in distributed systems than in stand-alone systems.

If it is not just the distribution of a resource per se, for example of a memory in the data storage device cited at the outset, but also qualities of a resource, e.g. memory contents within the data storage device, which are involved then even greater performance problems can be expected. By way of example, a plurality of processes operated under one operating system, e.g. UNIX, access common memory areas, “shared memories”. The common memory areas are used for interprocess communication, for example. The operating system manages the processes' access operations, e.g. in order to control competing read and write access operations to the common memory areas by the processes. The processes respectively ask the operating system for access to those common memory areas to which they currently need to have read and/or write access, respectively. Access management by the operating system is time-consuming and complicated, and the effectiveness of the overall system is therefore low.

The aforementioned problem becomes even more complicated if common memory areas are distributed over various systems, e.g. different computers, as “distributed shared memories” (DSM).

The aforementioned problems of common memory areas also arise, inter alia, in databases in which there are locking mechanisms for access to jointly used information areas.

The invention is based on the object of providing a method and also apparatuses for regulating access to data which allows operations which are as fast as possible while minimizing unnecessary data traffic.

The invention achieves this object by virtue of the individual systems reserving themselves free data areas or address areas in the data source and by virtue of the reserved areas then being blocked for access by other individual systems, with areas which are speculatively extended in comparison with the directly required areas being reserved.

The invention can be applied, by way of example, in connection with distributed shared memories (DSMs), with the NUMA (Non-Uniform Memory Addressing) architecture, with SMP (Symmetric MultiProcessor) computers or the like. It reveals particular advantages in distributed systems. The invention can be implemented using hardware or software, or else using a combination of hardware and software.

The object is also achieved by a data storage device and by individual systems cooperating with the data storage device, for example in the form of individual modules and/or network nodes. The data storage device receives reservation requests from the individual systems, these requests being used by the individual systems to request reservation of free data areas or address areas in the data storage device. Reservation means in the data storage device reserve the speculatively extended areas for the individual systems. The reservation means may also reserve the required areas. In this case, it is particularly preferable for the individual systems to use one or more address statements to specify the areas which they respectively require directly. In this refinement of the invention, what matters is thus not only that the data storage device reserves memory areas, which may be arranged at an arbitrary storage location, for the individual systems in the first place, but also memory areas which the individual systems specify using address statements. This also applies to the requesting of a speculatively extended area by an individual system, such a request also being able to be made at the same time as a directly required area is requested, the location of the latter request being defined by the individual systems.

In principle, however, it is also possible for the individual systems in the data storage device to make no statements regarding the directly required areas, but rather to request speculatively extended areas from the outset. This is because the speculatively extended area can also be regarded as being a superset or superior area of a directly required memory area.

Although the data storage device reserves speculatively extended areas for the individual systems where possible, it at least reserves the directly required memory area. However, it may be that a smaller speculatively extended memory area is reserved than has been requested, or even areas which are not even required directly have been reserved. Subsequent communication allows the data storage device in the respective individual system to solve this problem.

Particularly in this connection, it is particularly advantageous that not just the directly required areas but also speculatively extended expansion areas are reserved. The extension to the directly required areas can be indicated by the individual systems in the respective reservation request. However, it is also possible for the data storage device to extend the directly required areas speculatively by expansion areas on its own, so to speak. In any case, the individual systems can access both the directly required areas and the speculatively extended areas without the need for a fresh reservation request. The individual systems have various possible variants. By way of example, they may be databases, operating systems or the like. It is also possible for an individual system to be represented by a computer, for example a personal computer. In another variant of the invention, the individual systems are also individual processes or modules, for example, which are operated under the management of an operating system or distributed operating system. The same also applies, in principle, to the data storage device, which may be a data storage module in a database, in an operating system or the like, for example. The data storage module manages memory in the system, which is represented by a computer, for example.

Reservations, also called locks, always result in a waiting time on account of the communication latencies. If, each time, only the currently required data area or address area were to be used by a lock which is currently required then there would again be a waiting time every time a new lock is required. By reserving a speculatively extended area, there is thus no need to effect a new access operation in time-consuming fashion each time, but rather the speculatively extended area already obtained can be used without a waiting time, for example can be forwarded to further individual systems as subownership as soon as corresponding demands are made. If the speculatively extended area is not required, it can always be sent again to other individual systems which need it. Overall, this significantly reduces the data access time. The inventive procedure brings about speculative prior distribution of the available data areas which can be corrected retrospectively by current requests. Speculatively requested or reserved areas can be returned using various strategies.

The measures cited in the subclaims permit advantageous developments and improvements of the method specified in claim 1.

The data storage device is preferably used as a communication platform for the individual systems.

By way of example, two or more individual systems use a common area of the data storage device. The individual systems enter information into such a data area and/or read information therefrom. The precautionary speculative reservation of expansion areas means that it is then also possible for the individual systems to be able or permitted to read and/or change not only the information in the directly required area but also information contained in the expansion area(s).

The invention is based on the insight that normally only the information contained in directly required areas is initially relevant to an individual system. Frequently, an individual system later also requires information which is located next to the area which is originally required directly.

The return of speculatively reserved areas, that is to say expansion areas, can be released at least in part upon a corresponding reservation request from another individual system or from a data storage device. The data storage device can make the return without enquiring in an individual system whose expansion area(s) need(s) to be reduced. However, it is expedient for the data storage device to inform an individual system about these measures prior to the reduction or return of an expansion area where possible.

However, it is particularly preferable for the data storage device to ask the individual system for its agreement to the return of an expansion area beforehand, e.g. using a “retract message”. The individual system can then agree to the return of the entire expansion area which is to be returned, or else just a portion of it, e.g. using a “retract grant message”.

In this case, one advantageous option is for the expansion area to be released upon a reservation request only if said expansion area is requested as a directly required area by the requesting individual system. As an opposite extreme, the expansion area can also be released, in particular also released in full, upon a reservation request by another individual system if said expansion area is requested only as an expansion area by this other individual system. However, it should be noted that directly required areas are not released in favor of requests for expansion areas. Intermediate strategies are likewise possible, that is to say upon a reservation request by another individual system only a particular part of the expansion area is released if said expansion area likewise relates only to the expansion area in the case of this other individual system. In this context, by way of example, half of the requested expansion area or of the expansion area reserved for the first individual system can be released.

The individual system forming the system are databases and/or operating systems, for example.

The individual systems and the at least one data storage device are expediently decoupled from one another by means of buffer cache units. Such buffer chips ensure decoupling of activities, e.g. between inputs and outputs, and are suitable for adapting the access response over time between slow and fast chip instances.

The release of the directly required area upon a reservation request by another individual system is expediently dependent on the urgency of the respective reservation. In the simplest case, such a release is prevented, in principle, but urgency priorities can be introduced, which means that, by way of example, access by an individual system with very high priority can force the release of an area with very low urgency which has been reserved by another individual system.

The reservations can relate to read access operations, write access operations or both. In the case of exclusive read access operations, multiple reservations of a directly required area and/or of an expansion area are also possible, e.g. “read locks” or “shared locks”, while for write access operations exclusive reservations are expedient, “write locks” or “exclusive locks”.

Particularly in the case of expansion areas, it is advantageous for these also to be allocated to various individual systems a plurality of times in full or in part, possibly overlapping or the like, for exclusive read access operations (read lock). In the case of write access operations (write lock), multiple access operations are admissible neither in the case of directly required areas nor in the case of expansion areas.

Exemplary embodiments of the invention are explained by way of example below with reference to the drawings, in which:

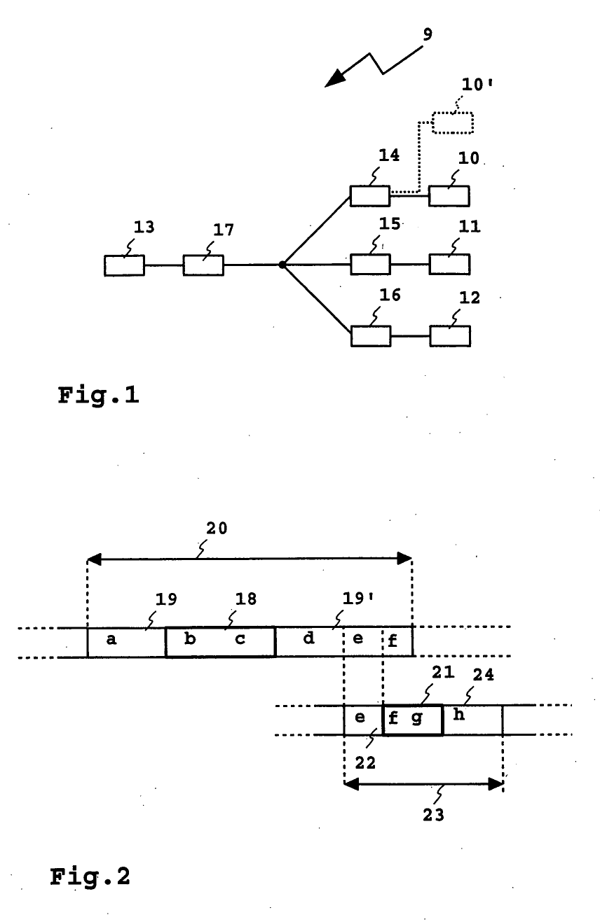

FIG. 1 shows a schematic illustration of a first exemplary embodiment of the invention with a system comprising three individual systems and a data storage device,

FIG. 2 shows a schematic illustration to explain the reservation of address areas,

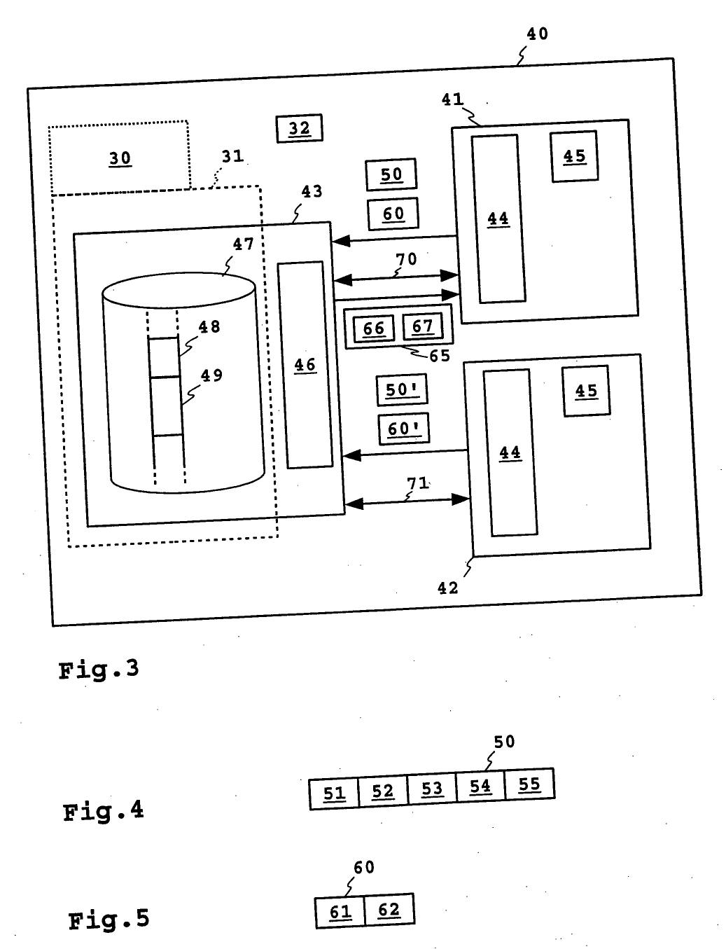

FIG. 3 shows a schematic illustration of a second exemplary embodiment of the invention with a system which is of modular design and which comprises two individual systems and a data storage device,

FIG. 4 shows a schematic illustration of a reservation request, and

FIG. 5 shows a schematic illustration of a release message.

The distributed system 9 shown in FIG. 1 comprises three individual systems 10-12 and 10′, which may be databases and/or operating systems, and also a data storage device 13, which may be an arbitrary data source. The individual systems 10-12 and the data storage device 13 are connected to one another by means of buffer chips 14-17, which may be buffer cache units. Such buffer chips are used for decoupling and for adapting the access response over time between slow and fast chips and may also be configured in the manner of individual systems based on the invention. The individual systems 10-12 and the data storage device 13 may also be connected to one another by means of other coupling elements or types of connection.

The number of individual systems 10-12 is practically arbitrary, with it also being possible for a plurality of data storage devices to be provided. Not only are the individual systems 10-12 able to access the data storage device 13, but it is also possible—in the case of a plurality of data storage devices 13—for such data storage devices likewise to access one another, for example recursively. Such data storage devices 13 may also be or form parts of individual systems 10-12. In principle, the data access operations may be read access operations and/or write access operations.

The reservations of data areas or address areas, “locks”, on the data storage device 13 or on further data storage devices by individual systems 10-12 are explained below with reference to FIG. 2.

If an individual system 10-12 wishes to access data in the data storage device 13, it requests for the action which it is to carry out not only the directly required address area 18 (shown by a bold line) but also an area 20 speculatively extended by expansion areas 19, 19′.

The request for a lock of this type cannot normally take effect until the corresponding areas are free. Following the reservation, that is to say the setting of the lock, other individual systems are no longer readily able to access the reserved area, that is to say the speculatively extended area 20. The speculatively extended area 20 is available directly without any waiting time for subsequent actions by the respective individual system 10-12, that is to say that if addresses in the expansion areas 19, 19′ are needed, for example, this can be done in time-saving fashion without any further lock requests.

By way of example, the individual system 10 has reserved the area 20 speculatively extended by expansion areas 19, 19′ for itself in the data storage device. The individual system 10 can now access not only the information b and c stored in the directly required area 18, and even possibly change it, but also the information a, d, e and f stored in the expansion areas 19, 19′. Unlike in known systems, in which just the directly required area 18 is reserved, the individual system 10 can access the expansion areas 19, 19′ and can read and/or modify the information a, d, e and f without a fresh reservation request.

It is also possible that instead of the individual system 10 the buffer chip 14 operates in the manner of an inventive individual system and requests extended memory areas in the data storage device 13. In such a scenario, the individual system 10 could respectively request only directly required areas from the buffer chip 14, and the buffer chip 14 could manage speculatively extended areas which it has requested itself, for example, or has received from the data storage device 13 without any special request. If the individual system 10 or a further individual system 10′ connected to the buffer chip 14 request further memory areas from the buffer chip 14, the buffer chip 14 reserves these memory areas from the extended areas where possible. Further time-consuming reservation in the data storage device 13 is not normally required for this.

FIG. 2 now shows that another individual system which is to access addresses in the data storage device 13 such that intersections would occur. In the exemplary embodiment, a lock request from another system is shown with a directly required area 21 (shown in bold lines) and expansion areas 22 and 24, that is to say that the other individual system requests a speculatively extended area 23 which intersects the first individual system's speculatively extended area 20 which has already been reserved. The following alternative solutions may now be employed:
1. The first individual system releases the entire expansion area 19′.
2. The first individual system releases the expansion area 19′ only in as much as it is overlapped by the speculatively extended area 22 associated with the second individual system.
3. The first individual system releases the expansion area 19′ only in as much as it is overlapped by the directly required address area 21 associated with the second individual system.
4. The first individual system releases the expansion area 19′ in as much as it is overlapped by the directly required address area 21 associated with the second individual system, and additionally part of the area overlapped by the expansion area 22 associated with the second system is released.

The fourth alternative allows the area claimed by both expansion areas 19′ and 22, for example, to be split in half or to be split on the basis of an urgency key if the locks have different associated urgency stages. These urgency stages may also govern which alternatives are used to proceed.

If the directly required address area 18 associated with the first individual system is overlapped by the expansion area 22 associated with the second individual system, there is normally no release or return of the directly required address area 18 associated with the first individual system, not even in part. If directly required address areas 18 and 21 overlap, there is generally no release or return of the area reserved first, but in this case too other return criteria can be introduced on the basis of urgency stages for the locks, on the basis of statistical analyses, for earlier lock operations and/or memory access operations or on the basis of other criteria.

A plurality of different address areas may also be reserved simultaneously by an individual system or a data storage device in an atomic operation, where the criteria explained above apply to the individual reservations if the requested areas are not free.

The text below describes a scenario in which the individual systems 10 and 11 communicate with one another by reading and writing information in common areas within the data storage device 13.

By way of example, the initial situation is the scenario above, in which the individual system 10 has requested the extended area 20 from the data storage device 13. By way of example, the individual system 10 has written the information e and f to the expansion area 19′. The individual system 11 now asks the data storage device for the directly required area 21 which is to be extended, preferably speculatively, to the area 23. In this case, it is possible for the individual system 10 to register the desire to extend the directly required area 21 with the data storage device 13. It is also possible for the data storage device 13 to extend the directly required area 21 by the expansion areas 22 and 24 on its own. In any case, the individual system 11 can read the information f when at least the directly required area 21 has been reserved for it. This is possible, by way of example, if the data storage device 13 implements the third variant explained above. If the data storage device 13 implements the second variant explained above, in which it also reserves the expansion area 22 for the individual system 11, then the individual system 11 can also read the information e. That part of the expansion areas 19′ and 22 which contains the information e then forms a common area which the individual systems 10 and 11 use to communicate. In any case, in both scenarios, the data storage device 13 is used as a communication platform for the individual systems 10 and 11. It goes without saying that further data areas and address areas in the data storage device may also be used for communication between the individual systems 10, 11 and 12.

FIGS. 3, 4 and 5 are used below to illustrate an exemplary sequence for the reservation and release of data areas and address areas in an inventive data storage device, which is presented by a data storage module 43 in the second exemplary embodiment shown in FIG. 3.

The data storage module manages memory 31 in a computer 40 and provides the individual modules 41, 42, which are inventive individual systems, with this memory 31 at least in part. The modules 41 to 43 are program modules, for example, whose program code is executed by one or more processors 30, in the computer 40. The modules 41 to 43 are operated under the control of an operating system 32. The data storage module 43 can form part of the operating system 32 or of a database, for example.

The individual modules 41, 42 are application programs, for example. The computer 40 is shown very schematically and may have further means (not shown), for example input/output means, network interfaces or the like. By way of example, the computer 40 may have a monitor, a loudspeaker, a keyboard or the like.

The individual modules 41, 42 reserve data areas and address areas in the data storage module 43. Some of the reserved data areas and address areas are used for interprocess communication by the individual modules 41, 42.

By way of example, memory area can be reserved in the following manner:

As an example, communication means 45 instruct requesting means 44 to request a directly required address area 49 in a storage means 47 in a memory 31. The storage means 47 is a RAM (Random Access Memory) and/or a hard disk store, for example. The communication means 45 wish to write information which has been sent to the individual module 42, for example, to an area of the storage means 47 which can be addressed using the address area 49. The reservation means 44 send a reservation request 50 to the data storage module 43. The reservation request 50 is a function call, an interprocess message or the like, for example, and may have the name “Lock_Address” or “Get_Address”, for example. The reservation request 50 has the following contents, for example: an address statement 51, which defines the first address within the address area 49, for example. The address area 49 is preferably linear. In addition, the reservation request 50 contains a statement 52 about the minimum length of the desired address area which is to be reserved and also a statement about the maximum required length of the address area which starts at the address statement 51. The statements 51, 52 thus define the directly required address area 49, and the statement 53 defines one or more speculatively extended areas. The statement 53 may contain one or more length statements and/or address statements, for example. The statements 51, 52 could also indicate the first and last addresses of the area 49. The reservation means 44 request a larger address area from the data storage device 43 than is directly needed. The reservation request 50 may optionally also contain a statement 54 indicating, by way of example, whether reading and/or writing is planned in the address area which is to be reserved, whether the address area needs to be initialized by writing start values, for example, or the like. An optional blocking statement 55 in the reservation request 50 indicates whether the address area to be reserved needs to be blocked to read and/or write access operations from other individual modules. The reservation request 50 may also contain sender and receiver identifiers or the like.

Using the reservation request 50, reservation means 46 in the data storage module 43 reserve both the directly required address area 49 and the expansion address area 48, which follows the address area 49, for the individual module 41. The individual module 41 can then write information to the address areas 48, 49, can read information therefrom or the like. The interactive access operations by the individual module 41 to the address area 48, 49 are shown schematically by an arrow 70 in the drawing.

Using a confirmation message 65, the data storage module 43 confirms to the individual module 41 that the address area 48, 49 has been reserved for the individual module 41. By way of example, the confirmation message 65 contains an address statement 66 and also a length statement 67, which indicate the start and the length of the actually reserved area, which in the present case comprises the address areas 48, 49. In principle, it would also be possible for a smaller area to have been reserved, e.g. only the directly required address area 49. The confirmation message 65 may also contain further information (not shown), e.g. similar to the reservation request 50.

When the individual module 41 has ended read and/or write access 70 to the address areas 48, 49, the individual module 41 sends a release message 60, denoted by “Unlock_Address”, for example, to the data storage module 43. By way of example, the release message 60 contains an address statement 61, which in the present case corresponds to the address statement 51. Alternatively, the address statement 61 could be another address located within the areas 48, 49. The address statement 61 defines the location of the data area or address area which is to be released. By way of example, the address statement 61 contains the first address which is to be released. In addition, the release message contains a length statement about the area which is to be released, for example the length of the address areas 48, 49 overall. It is also possible for the release message 60 to release just a part of the address area 48, 49. The release message 60 may also contain sender and receiver identifiers.

The individual module 42 can then use a reservation request 50′ to reserve the address areas 48 and/or 49 or part thereof and to read and/or modify information stored there by the individual module 41.

The individual module 42 uses a release message 60′ to release the reserved memory areas. It goes without saying that the data storage module 43 can implement variants 1 to 4 explained in connection with FIG. 2 in the event of competing reservation requests from the individual modules 41, 42 or from other individual modules (not shown).

In addition, in the event of reservation requests which relate to address areas already reserved elsewhere, the reservation means 46 may also send a retraction message (e.g. with the name “Notify_Lock” or “Retract_Address”) to an individual system for which an address area has already been reserved if part of this address area needs to be reserved for another individual system. The address area to be retracted is preferably an expansion area. Alternatively, it may be a directly required area.

In a response to the retraction message, e.g. called “Retract_Grant”, the individual system can then agree to the full or partial return of the reserved area. In that case, by way of example, a speculatively extended area is released in full, in half or in another fraction. The confirmation of the address area release can be sent to the data storage device and/or to the individual system which is requesting the address area in competition.

1. A method for regulating access to data in at least one data storage device (13; 43) in a system (9) comprising a plurality of individual systems (10-12), in which the individual systems (10-12) reserve themselves free data areas or address areas in the data storage device (13; 43) and the reserved areas are then blocked for access by other individual systems (10-12), with areas (20, 23; 48) which are speculatively extended by expansion areas (19, 19′) in comparison with the directly required areas (18, 21; 49) being reserved.

2. The method as claimed in claim 1, characterized in that the individual systems identify a directly required area from at least one address statement (51).

3. The method as claimed in claim 1, characterized in that at least part of the data storage device (13; 43) is provided as a communication device for the individual systems (10-12).

4. The method as claimed in claim 1, characterized in that at least two individual systems (10, 11) use a common area (22) of the data storage device (13; 43).

5. The method as claimed in claim 1, characterized in that the system comprising a plurality of individual systems (10-12) is a distributed system.

6. The method as claimed in claim 1, characterized in that at least part of a respective reserved expansion area (19, 19′) going beyond the directly required area (18) is released upon a reservation request (50) relating to at least part of the reserved expansion area (19, 19′) from another individual system (10-12) or from a data storage device (13; 43).

7. The method as claimed in claim 1, characterized in that the expansion area (19, 19′) is released upon a reservation request (50) coming from another individual system (10-12) if said expansion area is requested as a directly required area (21) by this other individual system.

8. The method as claimed in claim 7, characterized in that the expansion area (19, 19′) is also released upon a reservation request (50) coming from another individual system (10-12) if said expansion area is requested as an expansion area (22) by this other individual system.

9. The method as claimed in claim 7, characterized in that only a particular part of the expansion area is released upon a reservation request (50) coming from another individual system (10-12) if said expansion area likewise relates only to the expansion area (22) in the case of this other individual system.

10. The method as claimed in claim 1, characterized in that the individual systems (10-12) are databases and/or operating systems and/or individual modules.

11. The method as claimed in claim 1, characterized in that the individual systems (10-12) and the at least one data storage device (13; 43) are decoupled from one another by means of buffer cache units (14-17).

12. The method as claimed in claim 1, characterized in that the release of the directly required area (18) upon a reservation request (50) coming from another individual system (10-12) is dependent on the urgency of the respective reservation.

13. The method as claimed in claim 1, characterized in that reservations relate to the read and/or write access.

14. A data storage device for regulating access to data in a system (40, 9) comprising a plurality of individual systems (10-12), particularly individual modules, having reservation means (46) for reserving free data areas or address areas (48, 49) in the data storage device (13; 43) using reservation requests (50) from the individual systems (10-12), where the reservation means (46) block the reserved areas for access by other individual systems (10-12), and where the reservation means (46) are designed to reserve areas (20, 23; 48) which are speculatively extended in comparison with the directly required areas (18, 21).

15. The data storage device as claimed in claim 14, characterized in that the reservation means (46) are designed to ascertain an area which is directly required by an individual system by evaluating at least one address statement (51) which is contained in a reservation request (50) requesting the area.

16. The data storage device as claimed in claim 14, characterized in that upon a competing reservation request (50) from a second individual system (11) the reservation means (46) reserve at least part of a speculatively extended area (20, 23; 48) which is reserved for a first individual system (10) for the second individual system.

17. An individual system, particularly an individual module, for cooperation with a data storage device (13; 43) as claimed in claim 14 for regulating access to data in a system comprising a plurality of individual systems (10-12), having requesting means (44) for reserving free data areas or address areas in the data storage device (13; 43) using reservation requests (50), where the data storage device (13; 43) blocks the reserved areas for access by other individual systems (10-12), and where the requesting means (44) are designed to reserve areas (20, 23; 48) which are speculatively extended in comparison with the directly required areas (18, 21; 49).

18. The individual system, particularly an individual module, as claimed in claim 17, characterized in that the requesting means (44) are designed to send at least one address statement (51) for identifying at least one directly required area in a reservation request (50) requesting the area in the data storage device (13; 43).

19. The individual system, particularly an individual module, as claimed in claim 17, characterized in that it has communication means for communicating with at least one further individual system about a common area (18, 21; 49) which is at least intermittently reserved in the data storage device (13; 43), where the individual systems respectively identify the common memory area from at least one address statement (51).

20. The data storage device as claimed in claim 14, characterized in that it contains program code which can be executed by a processor (30) in a computer (40).

21. A message for communication between a data storage device as claimed in claim 14, characterized in that it contains a reservation request (50) or a reservation confirmation for at least one speculatively extended area (20, 23; 48).

22. A storage medium having a data storage device (13; 43) and/or an individual system, particularly an individual module, as claimed in claim 20.
